(19) United States
(12) Patent Application Publication
(10) Pub. No.: US 2026/0276846 A1
(43) Pub. Date: Sep. 17, 2026

(54) RADIATION DETECTION METHOD AND SYSTEM

(71) Applicants: KROMEK LIMITED; UCL Business Limited, London (GB)

(72) Inventor: Alexander Cherlin, Sedgefield (GB)

(21) Appl. No.: 19/470,458

(22) PCT Filed: Apr. 2, 2024
(86) PCT No.: PCT/GB2024/050894

§ 371 Date: Sep. 29, 2025

(30) Foreign Application Priority Data
Mar. 30, 2023 (GB) 2304760.8
Mar. 30, 2023 (GB) 2304762.4
May 4, 2023 (GB) 2306627.7

(51) Int. Cl. G01T 1/29

(52) U.S. Cl. CPC G01T 1/2985

(57) ABSTRACT

A method of detecting radiation from a target object is described that makes use of a radiation detector module including a collimator having a plurality of apertures having a spread angle for emergent radiation. The method exploits this by: associating a target object with an internal radiation source such that radiation emergent from the target object is caused to pass through the collimator to be incident upon a detector; receiving a plurality of responses each being a response to an interaction with incident radiation occurring within the detector; determining, for each of the plurality of responses, a position of each interaction within the detector in three dimensions comprising two area dimensions and a depth dimension; processing the said plurality of responses by simultaneously processing position data in such manner as to obtain information about parts of the target object within an effective field of view that is not directly congruent with the primary field of view.

### FIELD OF INVENTION

The invention relates to a method for the detection of radiation from a target object, or from a particular region of interest therein, and in particular relates to a method adapted for the detection of radiation from a target object where the target object creates a low signal at the detector. In possible applications, the method relates to a method of detection of radiation from a target object provided with an introduced radioisotope to serve as a source therein, which applications include techniques where the target object is human or other animal tissue.

### BACKGROUND TO THE INVENTION

Various scenarios exists where it might be desirable to obtain more accurate information about radiation which is being emitted from a source and received at a detection system. In particular, a wide range of scenarios exists in which it might be desirable to resolve the information, for example spatially and/or spectroscopically, to provide additional information about the source and/or about materials through which the radiation has passed through between source and detector.

Such scenarios include, but are not limited to, scenarios where a test object and detector are deliberately spaced apart, the test object is subjected to irradiation for example from an internal or external source, and radiation emergent from high activity areas in the test object is measured at the detector to determine information in respect of the test object, and in particular to determine information from a target region of interest of the test object.

Such scenarios in particular include scenarios where a test object is positioned between two spaced detectors, the test object is subjected to irradiation for example from an internal or external source, and radiation emergent from high activity areas in the test object is measured at the two detectors to determine, for example with spatial resolution for imaging, information in respect of the test object.

Examples of methods applicable to such scenarios include nuclear medicine imaging methods, where radiation from a radioisotope source is caused to pass to a part of the body comprising a region of interest of a subject under investigation, and where spatially registered information about the radiation received at a remote detector is used to obtain information regarding the structure and/or the real time physiological function of that part of the patient's anatomy, and for example to build up an image of that structure and/or physiological function.

A technique finding application for the investigation of target objects might seek to associate the object with radioisotope to serve as a source, and for example to introduced a radioisotope into the object to serve as a source therein. Such a technique finds known application where the target object is human or other animal tissue, either present in the body or in the form of a sample therefrom, and in particular finds known application for such medical imaging.

However, discussion of such applications is by way of example only, and the invention is not limited to medical or imaging applications.

An example of an established nuclear medicine imaging technique is single-photon emission computed tomography (SPECT) which is a nuclear medicine tomographic imaging technique using gamma rays. The technique requires the delivery into the patient, for example via the bloodstream, of a gamma-emitting radioisotope. In a typical application, the radioisotope is bound to a specific ligand, allowing it to be carried to and bound within a region of interest in the body of the subject under investigation.

The radioisotope emits gamma rays which passes through the tissue of the subject under investigation and can be detected at a suitable detector, and for example by a gamma camera. SPECT imaging by the gamma camera acquires multiple two-dimensional images which are then built up into a three-dimensional dataset using a standard tomographic reconstruction technique.

Similar principles are employed in positron-emission tomography (PET). In this case a positron-emitting radioisotope, again typically as part of a radioligand, is introduced into the body. In this case, the emitted positron is locally annihilated, and the system detects the pairs of gamma rays emitted indirectly by this annihilation event.

Both techniques are particularly powerful, allowing not merely imaging of the relevant part of the body but active functional imaging of biological processes.

A known technique for imaging of breast tissue, for example to detect abnormalities that might lead to the early detection of breast cancer, is mammography. Standard mammography uses X-rays to create images. These images are then analysed for abnormal findings and in particular for characteristic dense masses that might indicate potential tumours for example. These patients are then referred for further, usually more invasive, testing. Standard mammography is thus a widely adopted first stage screening technique.

However, the response of normal but relatively dense breast tissue to the low-energy x-rays can be similar to that of the sort of masses that might be indicative of potential development of many commonplace tumours, and the ability of the technique to distinguish in those patients which have a high proportion of high density breast tissue is consequently reduced.

Molecular breast imaging (MBI) is a developed nuclear medicine imaging technique that utilises many of the above principles of SPECT-type techniques. A radioisotope source, again typically bound to a suitable ligand to cause it locate within breast tissue, is introduced into the subject under investigation. A suitable system of small semiconductor-based gamma cameras in a configuration generally corresponding to that for a more conventional mammogram is used to detect radiation from the source after it has passed through the breast tissue. The technique can be particularly effective at detecting incipient tumours, as it can differentiate structures and physiological activity. It does generally subject the patient under investigation to higher overall radiation dose however, which has tended to limit its application as a first stage screening technique.

In all nuclear medicine imaging techniques, there is a clear imperative to keep the radioactivity of the source, and the consequent dose of radiation received by the subject under investigation subject under investigation, as low as possible. The resultant low signal to be collected at the detector presents particular problems in relation to both detection and resolution of data.

The effective development nuclear medicine imaging embodying techniques such as SPECT, PET or MBI is therefore a compromise between the requirement for effective collimation with substantially complete one to one registration in an x, y direction, for example using parallel hole collimators with a very low spread angle, the consequent reduction in signal by the collimator, and the requirement for the lowest radiation dose source possible. A particular downside of such a system is the limited angular sampling provided by multi-pinhole collimators in a direction perpendicular to the collimators, which results in a limited spatial resolution in a direction perpendicular to the detectors.

A possible alternative approach to this problem is described in WO2021/176232A1 and WO2022/090722A1. This discloses a method of detecting radiation from a source, for example for nuclear medicine imaging, in which the use of multi-apertured collimators that do not have the low spread angle of parallel hole collimators, for example consisting of pinholes or slits is envisaged. Such multi-apertured collimators with a non-trivial spread angle for emergent radiation may allow more radiation to pass but tend to produce projection overlap (multiplexing), which can result in image artefacts. This may be seen as a disadvantage. However WO2021/176232A1 and WO2022/090722A1 further exploits detectors with depth resolution so as to determine position in three dimensions of each interaction within the detector and draw inferences therefrom regarding the pattern of radiation from the source, potentially not only mitigating multiplexing effects but exploiting them to collect additional information.

The present invention finds application in particular in relation to techniques for medical and/or imaging applications such as above described, and in particular in relation to nuclear medicine imaging embodying techniques such as SPECT, PET or MBI, and examples of the same are discussed herein. However, the invention is not limited to medical or imaging applications.

There is a general desire to provide for alternative detection systems and methods which allow for the resolution of information concerning radiation from a source object, in particular from a low-signal source object and for example in cases where a low level of radiation level at the object is desirable.

There is a particular desire therefore to collect as much information as possible from a target object which has been subjected to a given level of irradiation.

There is a particular desire to collect information that improves resolution and/or sensitivity in the direction perpendicular to a detector.

There is a particular desire to provide such alternatives which might have applicability in nuclear medicine imaging, and which might address those conflicting considerations in a more effective and efficient way and provide for improved resolution of physiologically relevant data from a subject and/or reduced radiation dose levels.

### SUMMARY OF INVENTION

In accordance with the invention in a first aspect, a method of detecting radiation from a target object comprises:
providing a radiation detector module comprising:
a detector having an area and a depth and configured to generate successive responses to successive interactions with incident radiation occurring within the detector in such manner as to determine a position of each interaction in three dimensions comprising two area dimensions and a depth dimension;
a collimator associated with the detector, wherein the collimator has a plurality of apertures having a spread angle for emergent radiation;
positioning the radiation detector module relative to a region of interest of the target object to define, where the detector module area faces the target object, a primary field of view;
associating the target object with an internal radiation source, such that radiation from the source passes through at least a part of the target object to emerge therefrom, such that radiation emergent from the target object is caused to pass through the collimator to be incident upon the detector;
receiving a plurality of responses each being a response to an interaction with incident radiation occurring within the detector;
determining, for each of the plurality of responses, a position of each interaction within the detector in three dimensions comprising two area dimensions and a depth dimension;
processing the said plurality of responses by simultaneously processing position data in such manner as to obtain information about parts of the target object within an effective field of view that is not directly congruent with the primary field of view.

The method may comprise the use of a single radiation detector module positioned in suitably spaced manner away from the target object with an internal radiation source, such that radiation from the source passes through at least a part of the target object to be incident upon the detector module.

The method may comprise the use of two detector modules spaced away from the target object in any suitable juxtaposition to collect additional information. The method may comprise the use of three or more detector modules in any suitable two-or three-dimensional arrangement.

In a possible embodiment, two or more detector modules may be disposed around a target object in a suitable array such as in a planar array.

In a possible embodiment, paired detector modules are used, one each side of the target object, to collect additional information.

Thus, in this case, a method of detecting radiation from a target object comprises:
providing first and second radiation detector modules each comprising:
a detector having an area and a depth and configured to generate successive responses to successive interactions with incident radiation occurring within the detector in such manner as to determine a position of each interaction in three dimensions comprising two area dimensions and a depth dimension;
a collimator associated with the detector, wherein the collimator has a plurality of apertures having a spread angle for emergent radiation;
positioning the first and second radiation detector modules with a region of interest of the target object between them to define where the respective detector module areas overlap a primary field of view;
associating the target object with an internal radiation source such that radiation emergent from the target object is caused to pass through the respective collimators to be incident upon the respective detectors;
receiving a plurality of responses each being a response to an interaction with incident radiation occurring within one of the detectors;
determining, for each of the plurality of responses, a position of each interaction within the detector in three dimensions comprising two area dimensions and a depth dimension;
processing the said plurality of responses by simultaneously processing position data in such manner as to obtain information about parts of the target object within an effective field of view that is not directly congruent with the primary field of view.

The invention concerns obtaining information within an effective field of view that is not directly congruent with the primary field of view. In particular the invention concerns techniques and adaptations to improve both resolution and sensitivity within an effective field of view that is not directly congruent with the primary field of view.

The invention covers techniques and adaptations suitable to improve resolution and sensitivity in an extended field of view that extends beyond a primary field of view perpendicular to a detector plane and to adaptations suitable to improve resolution and sensitivity in a reduced field of view that does not extend, or does not exploit full sensitivity and resolution to the full extent of, a primary field of view perpendicular to a detector plane. The former may be advantageous where it is desirable to extend information gathering beyond the primary field of view. The latter may be advantageous where the entire field of view is not required. In either case, relative to methods and systems that have an unmodified field of view, the amount of information collected for a given amount of incident radiation may be materially enhanced.

Examples of techniques and adaptations to exploit either effect are described herein by way of exemplification. It will be understood that, except where specific statement is made to the contrary or where it is a necessary feature of the physics of the example that it cannot be so applied, examples may apply by analogy to the achievement of either objective.

Particular embodiments described herein comprise techniques and adaptations suitable to improve resolution and sensitivity over an extended field of view.

In such cases of the method, obtaining information about parts of the target object within an effective field of view that is not directly congruent with the primary field of view comprises simultaneously processing position data in such manner as to obtain information about parts of the target object within the primary field of view and further information about parts of the target object beyond the primary field of view.

Thus, more completely in such embodiments, a method of detecting radiation from a target object comprises:
providing a radiation detector module comprising:
a detector having an area and a depth and configured to generate successive responses to successive interactions with incident radiation occurring within the detector in such manner as to determine a position of each interaction in three dimensions comprising two area dimensions and a depth dimension;
a collimator associated with the detector, wherein the collimator has a plurality of apertures having a spread angle for emergent radiation;
positioning the radiation detector module relative to a region of interest of the target object to define, where the detector module area faces the target object, a primary field of view;
associating the target object with an internal radiation source, such that radiation from the source passes through at least a part of the target object to emerge therefrom, such that radiation emergent from the target object is caused to pass through the collimator to be incident upon the detector;
receiving a plurality of responses each being a response to an interaction with incident radiation occurring within the detector;
determining, for each of the plurality of responses, a position of each interaction within the detector in three dimensions comprising two area dimensions and a depth dimension;
processing the said plurality of responses by simultaneously processing position data in such manner as to obtain information about parts of the target object within the primary field of view and further information about parts of the target object beyond the primary field of view.

Analogously more completely where there are paired detectors, a method of detecting radiation from a target object comprises:
providing first and second radiation detector modules each comprising:
a detector having an area and a depth and configured to generate successive responses to successive interactions with incident radiation occurring within the detector in such manner as to determine a position of each interaction in three dimensions comprising two area dimensions and a depth dimension;
a collimator associated with the detector, wherein the collimator has a plurality of apertures having a spread angle for emergent radiation;
positioning the first and second radiation detector modules with a region of interest of the target object between them to define where the respective detector module areas overlap a primary field of view;
associating the target object with an internal radiation source such that radiation emergent from the target object is caused to pass through the respective collimators to be incident upon the respective detectors;
receiving a plurality of responses each being a response to an interaction with incident radiation occurring within one of the detectors;
determining, for each of the plurality of responses, a position of each interaction within the detector in three dimensions comprising two area dimensions and a depth dimension;
processing the said plurality of responses by simultaneously processing position data in such manner as to obtain information about parts of the target object within the primary field of view and further information about parts of the target object beyond the primary field of view.

Such techniques and adaptations may be applied when a field of view extending beyond the primary default FOV is not. In an example mode of operation, explored further below, the external parts of the detector arrays can be tilted away from the centre, thereby improving angular sampling and sensitivity over an extended FOV. This can be of the form of tilted detectors or angled pinholes. The system could still be stationary during acquisition. An extension of the technique allows for increasing or decreasing the field of view on each edge of the detector system, to allow for increased field of view or improved spatial resolution in different regions of the object to be scanned.

Other particular embodiments described herein comprise techniques and adaptations suitable to improve resolution and sensitivity over a reduced field of view.

In such cases of the method, obtaining information about parts of the target object within an effective field of view that is not directly congruent with the primary field of view comprises simultaneously processing position data in such manner as to obtain information with increased resolution and sensitivity about parts of the target object within a field of view that is reduced relative to the primary field of view.

Thus, more completely in such embodiments, a method of detecting radiation from a target object comprises:
providing a radiation detector module comprising:
a detector having an area and a depth and configured to generate successive responses to successive interactions with incident radiation occurring within the detector in such manner as to determine a position of each interaction in three dimensions comprising two area dimensions and a depth dimension;
a collimator associated with the detector, wherein the collimator has a plurality of apertures having a spread angle for emergent radiation;
positioning the radiation detector module relative to a region of interest of the target object to define, where the detector module area faces the target object, a primary field of view;
associating the target object with an internal radiation source, such that radiation from the source passes through at least a part of the target object to emerge therefrom, such that radiation emergent from the target object is caused to pass through the collimator to be incident upon the detector;
receiving a plurality of responses each being a response to an interaction with incident radiation occurring within the detector;
determining, for each of the plurality of responses, a position of each interaction within the detector in three dimensions comprising two area dimensions and a depth dimension;
processing the said plurality of responses by simultaneously processing position data in such manner as to obtain information with increased resolution and sensitivity about parts of the target object within a field of view that is reduced relative to the primary field of view.

Analogously more completely where there are paired detectors, a method of detecting radiation from a target object comprises:
providing first and second radiation detector modules each comprising:
a detector having an area and a depth and configured to generate successive responses to successive interactions with incident radiation occurring within the detector in such manner as to determine a position of each interaction in three dimensions comprising two area dimensions and a depth dimension;
a collimator associated with the detector, wherein the collimator has a plurality of apertures having a spread angle for emergent radiation;
positioning the first and second radiation detector modules with a region of interest of the target object between them to define where the respective detector module areas overlap a primary field of view;
associating the target object with an internal radiation source such that radiation emergent from the target object is caused to pass through the respective collimators to be incident upon the respective detectors;
receiving a plurality of responses each being a response to an interaction with incident radiation occurring within one of the detectors;
determining, for each of the plurality of responses, a position of each interaction within the detector in three dimensions comprising two area dimensions and a depth dimension;
processing the said plurality of responses by simultaneously processing position data in such manner as to obtain information with increased resolution and sensitivity about parts of the target object within a field of view that is reduced relative to the primary field of view.

Such techniques and adaptations may be applied when the full field of view is not required. In an example mode of operation, explored further below, the external parts of the detector arrays can be tilted towards the centre, thereby improving angular sampling and sensitivity over a reduced FOV. This can be of the form of tilted detectors or angled pinholes. The system could still be stationary during acquisition. An extension of the technique allows for increasing or decreasing the field of view on each edge of the detector system, to allow for increased field of view or improved spatial resolution in different regions of the object to be scanned.

To achieve either or both objectives of an extended or a reduced field of view, in accordance with the method, each radiation detector module is further modified by modification of one or more of the following:
the orientation of a detector or a part thereof,
the orientation of a collimator or a part thereof,
the orientation of or shape or configuration of some of the apertures of the collimator;
at least towards the edges of the detector module, so as to increase further the angular acceptance at the edge of the detector module.

In a practical implementation, the method may comprise:
positioning the radiation detector module and the collimator relatively to the region of interest of the target object such that the distance between the radiation detector module and the collimator is smaller than the distance between the collimator and the region of interest.

In the preferred case, where first and second radiation detector modules are provided either side of a target object, the method comprises:
positioning each radiation detector module and its respective collimator relatively to the region of interest of the target object such that the distance between the radiation detector module and the collimator is smaller than the distance between the collimator and the region of interest.

The invention exploits principles such as embodied by the system described in WO2021/176232A1 and WO2022/090722A1 in which a combination of a detector with a non-trivial depth using which successive responses to successive interactions with incident radiation occurring within the detector may be located in three dimensions comprising two area dimensions and a depth dimension, with a multi-apertured collimator having a non-trivial spread angle for emergent radiation such as a pinhole collimator that introduces complexity through divergence and overlap into the emergent radiation pattern, is exploited to draw additional inferences regarding the pattern of radiation from the target object, for example to construct an image of the target object.

That is to say, the system is distinctly characterised by the use of a collimator that has an array of multiple apertures inherently configured to produce divergence and overlap between the patterns of radiation from different apertures, the use of a detector with a non-trivial depth to capture information relating to this divergence and overlap by determining both a position and depth of the interaction within the detector, and the use of this detected complexity at the processing stage to draw additional useful inferences.

The method may thus exploit features of the method described in WO2021/176232A1 and WO2022/090722A1. For example, the method may comprise receiving a plurality of responses each being a response to an interaction with incident radiation occurring within the detector; determining, for each of the plurality of responses, a characteristic of the interaction, wherein the characteristic comprises at least a position and depth of the interaction within the detector; processing the said plurality of responses by simultaneously processing position and depth of interaction data in such manner as to accommodate the effect of multiplexing due to overlap of the projected radiation pathways from multiple apertures in the collimator at the detector on the detected position on the detector.

The method may further comprise determining an input dataset comprising the determined position and depth of each interaction within the detector, and processing the input dataset and producing therefrom a modified dataset comprising at least data comprising a position of each interaction modified in such manner as to accommodate the effect of multiplexing due to overlap of the projected radiation pathways from the multiple apertures. The method may further comprise processing the data for the successive plurality of particle interactions to generate an image dataset, wherein for example the image dataset is generated by a tomographic reconstruction and the method comprises processing position and depth of interaction data in such manner as to accommodate the effect of multiplexing on the reconstructed tomographic image dataset to reduce multiplexing artefacts in the reconstructed tomographic image.

In this instance however, the principle is being exploited to change the effective field of view, and in embodiments at least to extend the effective field of view of the detector module and in the preferred case, by arranging the system such that the distance between each radiation detector module and its collimator is smaller than the distance between the collimator and the region of interest, is further being exploited to extract information that exploits a minification effect rather than the magnification that would be inherent in usual methods.

The invention addresses the problem of imaging outside the standard field of view (FOV) of a conventional detector such as a conventional imaging camera. In a parallel hole collimation system, the FOV of is limited to the area which is directly above a single detector array, or directly between paired detector arrays. Therefore, no part of the object outside that area could be imaged. In a non-parallel aperture collimation system used by the invention, the data in the detectors is collected within a certain angular acceptance. The part of angular acceptance going beyond the FOV defined by the detector area would provide addition area which could be imaged without extending the detector coverage to be directly above it.

Some effect would be produced in an arrangement in which a single detector module comprising a detector or detector array and collimator or a pair of opposing detector modules comprising respective detector arrays and respective collimators were otherwise arranged in simple planar configuration, and in the case of the pair in parallel. The part of angular acceptance going beyond the FOV defined by the detector area would in such arrangement inherently provide addition area which could be imaged without extending the detector coverage to be directly above it. However the invention in optional embodiments may be further adapted in that each radiation detector module is further modified by modification of one or more of the orientation of a detector or a part thereof, the orientation of a collimator or a part thereof, the orientation of or shape or configuration of some of the apertures of the collimator. This modification is made at least towards the edges of the detector module. This modification is made so as to increase yet further the angular acceptance at the edge of the detector module and enable access to yet further information about parts of the target object beyond the primary field of view.

Thus, for example, a method of detecting radiation from a target object comprises:
providing first and second radiation detector modules each comprising:
a detector having an area and a depth and configured to generate successive responses to successive interactions with incident radiation occurring within the detector in such manner as to determine a position of each interaction in three dimensions comprising two area dimensions and a depth dimension;
a collimator associated with the detector, wherein the collimator has a plurality of apertures having a spread angle for emergent radiation;
positioning the first and second radiation detector modules with a region of interest of the target object between them to define where the respective detector module areas overlap a primary field of view;
associating the target object with an internal radiation source such that radiation emergent from the target object is caused to pass through the respective collimators to be incident upon the respective detectors;
receiving a plurality of responses each being a response to an interaction with incident radiation occurring within one of the detectors;
determining, for each of the plurality of responses, a position of each interaction within the detector in three dimensions comprising two area dimensions and a depth dimension;
processing the said plurality of responses by simultaneously processing position data in such manner as to obtain information about parts of the target object within the primary field of view and further information about parts of the target object beyond the primary field of view;
wherein each radiation detector module is further modified by modification of one or more of the following:
the orientation of a detector or a part thereof,
the orientation of a collimator or a part thereof,
the orientation of or shape or configuration of some of the apertures of the collimator;
at least towards the edges of the detector module, so as to increase further the angular acceptance at the edge of the detector module.

As discussed herein, the concept of modifying features of orientation of or shape or configuration of the elements of the detector module to increase the angular acceptance at the edge of the detector should be understood general as modifying relative to a simple planar conformance of detector and collimator and uniform shape and configuration of apertures in such manner as to increase the angular acceptance at the edge of the detector and extend the FOV yet further to supplement the extension of the FOV that is inherently produced even in a simple planar and parallel system by the apertures having a divergent spread angle.

Given the knowledge of the extension of FOV provided by the divergent spread angle of the apertures and the above discussion of its further extension by looking at modifications of orientation of or shape or configuration of the elements of the detector module to increase the angular acceptance at the edge of the detector, and in particular of doing so in a non-uniform manner towards the edges of the detector, the skilled person would consider options such as discussed below.

For example in some embodiments it may be useful to tilt the entire detector or collimator relative to the collimator or detector as the case may be or to a target object, or to tilt one collimator or detector or detector module of a pair relative to its pair. The effect of this tilt is to provide a larger extension to the extended field of view coverage, which now includes a contribution not only from the additional angular acceptance resulting from the diverging geometry of the aperture, but also a further extension attributable to the tilt angle.

It may not be appropriate to tilt the whole of a single planar collimator or detector or detector module. In embodiments, such as discussed further below, elements of the system may be modular. In such cases optionally only those modules close to the edges of the primary field of view are tilted such as to provide a larger angular acceptance at the edge of the detector. For example a detector may comprise a plurality of discrete detector formations arranged in a two-dimensional array. In such in such cases an embodiment of the method might be to change orientation and relative to a general detector plane of only some of the detector formations, for example the detector formations which comprise a part of the said array at or towards the edge of the detector, where it is most effective to extend the field of view.

Additionally or alternatively, modification may be made of the orientation of or shape or configuration of some of the apertures of the collimator in such manner as to increase the angular acceptance at the edge of the detector and extend the FOV yet further. In particular, apertures of the collimator may be configured in a non-uniform manner towards the edges of the detector module, for example being more divergent and/or outwardly directed towards the edges.

In a particular preferred case the method comprises at least configuring the collimator such that the shape of the plurality of apertures having a spread angle for emergent radiation is modified in areas of the collimator close to the edges of the primary field of view so as to be more divergent and to provide a larger angular acceptance at the edge of the detector;

The method of the invention in preferred embodiments comprises modifying features of orientation of or shape or configuration of the elements of the detector module to increase the angular acceptance at the edge of the detector and to supplement the extended FOV already even in a simple planar and parallel system by the apertures having a divergent spread angle. It will be appreciated that this may be effected as a fixed structural feature, the method comprising providing a detector module with such modifications as a fixed structural feature, for example by providing a detector module or part thereof or particular elements of a detector array that have a built in tilt angle or providing an array of apertures with non-uniform direction or divergency so as to provide a larger angular acceptance at the edge of the detector. It will be appreciated that this may be provided as an operably modifiable feature, for example by providing means to vary an orientation and for example a tilt angle of a detector module or part thereof or particular elements of a detector array, the method comprising operating such means to effect an orientation change, and for example to tilt a detector module or part thereof or particular elements of a detector array. Both of the above may be provided in a single system and in a single implementation of the method.

Combinations of the above with each other and with other methods of further increasing the angular acceptance at the edge of the detector module are within the scope of the invention.

The invention additionally offers the ability to exploit minification which may further improve the flexibility/usefulness of the imaging information that can be obtained from the region of interest.

The method thus offers additional functionalities not suggested in or provided by the prior art. These additional functionalities may enable an operator of the method to collect more information from a target object for any given process and level of irradiation. Particular advantages may accrue from this in nuclear medicine imaging, to provide for improved resolution of physiologically relevant data from a subject and/or reduced radiation dose levels.

It will be understood that where reference herein is made to a detector this applies to any detector effective to receive radiation from the source with a resolution such as to enable the required determining, for each of the plurality of responses, of a position and depth of the interaction within the detector. In particular, the singular includes the plural. The invention may be applied to a detector comprising multiple discrete detector formations and/or to a single detector formation defining multiple discrete detection areas and/or to a single detector formation defining a single continuous detection area which is virtually subdivided into separately addressed sub-areas. The plurality of responses may be received from multiple detectors.

In some applications of the invention, the detector is positioned generally perpendicular to a direction of radiation incidence to define an x, y plane of incidence perpendicular to a direction of radiation incidence and a z-direction corresponding to a depth of the detector, and it will be understood that a position of the interaction within the detector may constitute a position in x for a linear detector and in x, y for an area detector and a depth of the interaction within the detector may constitute a depth in z.

In some applications of the invention, the detector may be pixelated, which is to say the detector may be divided into a one-or two-dimensional array of discretely addressable sub-units being discrete elements and/or discretely addressable regions, for example defined on a surface generally perpendicular to a direction of radiation incidence, and it will be understood that a position of the interaction within the detector may constitute a localisation to a particular discretely addressable sub-unit and a depth of the interaction within the detector may constitute a depth below the surface of the said sub-unit. Sub-units may be discrete physical entities or may be defined virtually in digital manner, in the sense that detection area, which may be physically continuous is virtually sub-divided, a position is determined in x, y, and this determined position is used to assign the interaction to a sub-unit.

Where reference herein is made to such sub-units as pixels, this term will be understood unless the context expressly demands otherwise to include physically discrete pixel sub-units, clusters of the same, and sub-units defined virtually in digital manner as above.

The detector may be planar, that is, may define a planar detection surface in use presented to face and to receive incoming radiation from a test object. In the case where the detector comprises multiple discrete detector formations, these discrete detector formations may therefore lie in a single common plane such as to define collectively a planar detection surface. In such a case a primary FOV may be defined for example by projecting the detection plane in a normal direction to the detector.

In some embodiments of the method, a static scan is made. That is, the detector module(s) are maintained in a fixed position relative to the target object and the method comprises receiving a plurality of responses each being a response to an interaction with incident radiation occurring within the detector while the detector is in a fixed position relative to the target object.

In some embodiments of the method, a moving scan is made wherein during the scan the detector module(s) are moved relative to the target object around the primary field of view, and for example about an imaging axis that is an axis of symmetry for the field of view

That is, the detector module(s) are so moved relative to the target object and the method comprises receiving a plurality of responses, successive responses being responses to successive interactions with incident radiation occurring within the detector while the detector is so moved relative to the target object.

In each such case the invention could potentially extend or reduce the axial field of view (that is, the field of view in parallel with the imaging axis).

However, it will be understood that the operation of the method of the invention does not require or even necessarily render desirable a strictly planar detector. A detector may be generally planar but deviate from strict planarity. For example, where a detector comprises multiple discrete detector formations, some of these formations may be angled away from a general planar direction of the detector. Additionally or alternatively, nonplanar surfaces may be provided. Where such a detector is provided, the skilled person will nevertheless be able to determine without undue difficulty in conventional manner a general primary FOV provided by the detector in combination with its associated collimator and to determine an extended or reduced FOV in accordance with the principles of the method.

In a possible embodiment, paired detector modules are used, with one to be disposed in use on each side of the target object. In a simple embodiment, the method comprises providing first and second detector modules spaced apart on either side of a target object, with the paired detectors generally parallel. That is, if each detector is generally planar, the planes defined by a detection surface of each detector are generally parallel.

However, the paired detector embodiment is not limited to a method that provides planar detectors in parallel. In particular, advantageously in some embodiments to provide additional information, one or both of the detectors could be, in whole or in part, tilted away from a parallel configuration relative to the target object in use. The effect of this tilt is to provide a larger extension to the extended field of view coverage, which now includes a contribution not only from the additional angular acceptance resulting from the diverging geometry of the aperture, but also a further extension attributable to the tilt angle.

In some embodiments of the method, a simple planar detector with a single planar detection surface is provided, and the entire detector is tilted.

For example, in some embodiments, a detector may comprise a plurality of discrete detector formations arranged in a two-dimensional array. In such an embodiment, an alternative implementation of the method might be to change orientation and tilt relative to a general detector plane of only some of the detector formations, for example in particular only some of the detector formations which comprise a part of the said array at or towards the edge of the detector, where it is most effective to extend the field of view.

The orientations of the detector formations may be in any appropriate combination configured to be fixed, variable during a single examination operation, and variable between examination operations, to be adaptable to the requirements of a particular examination. In an apparatus for the implementation of the method, and in the implementation of the method, the orientation of a detector, or of individual detector formations making up the detector as the case may be, may be fixed during a scan, or may be adaptable to be tilted from a fixed direction during a scan.

In preferred embodiments, the method comprises processing the said plurality of responses to generate an image of the target object.

More completely, the method comprises processing the said plurality of responses by simultaneously processing position data in such manner as to obtain imaging information about parts of the target object within modified effective FOV, For example by simultaneously processing position data in such manner as to obtain imaging information about parts of the target object within the primary FOV and further in imaging information about parts the target object beyond the primary FOV, and co-operably processing the said imaging information to produce an image of the target object that extends beyond that which would be produced from the primary FOV.

In a possible embodiment, the method comprises arranging the system such that the distance between each radiation detector module and its collimator is smaller than the distance between the collimator and the region of interest. In this case, the method involves minification rather than magnification of said imaging information.

Thus, the method preferably comprises so arranging the system and processing the said plurality of responses by simultaneously processing position data in such manner as to obtain minified imaging information from the target object and co-operably processing the said imaging information to produce a minified image of the target object.

In this way, the invention confers additional functionality in relation to the generation of an image of a target object, and in particular allows some degree of imaging of parts of the target object beyond the primary FOV, which might be of use in cases where those parts are difficult to access, in cases where attempting to access them will require more complicated mobile scanning arrangements etc, and also provides additional functionality through generation of a minified image.

Preferably, the image is a reconstructed tomographic image.

Discussion of particular advantages of the invention has been made in relation to nuclear medicine imaging embodying techniques such as SPECT, PET or MBI. In a preferred embodiment, the method comprises a method for generating a nuclear medicine image, for example using such SPECT, PET or MBI, which is practised on a target object comprising biological tissue. The biological tissue may comprise a sample, or may comprise a part of the body of a living organism. In particular, the method may allow for examination of processes within the organism. Suitable organisms include human and non-human organisms, and the invention may be practised on the human body or tissues, the non-human animal body or tissues, or non-animal bodies or tissues. The method may provide images for a subsequent review stage, for example to determine whether further tests or interventions might be required or to make or contribute to a subsequent diagnostic step. The method may provide images as part of a diagnostic method to determine a condition state therefrom.

However, the invention is not limited to medical imaging, but finds application in any case where the additional field of view might be advantageous.

The method comprises associating the target object with a radiation source such that radiation from the source passes through at least a part of the target object, including at least a region of interest, to emerge therefrom and be detectable by suitably positioned radiation detectors. In some embodiments, a source may be placed in the vicinity of the target object, or the target object may be otherwise irradiated from a remote source. In other embodiments, the method may comprise inserting a source into the target object, and in particular causing a source to be distributed within a target object, at least in the vicinity of the region of interest. This last method may be particularly suited to the investigation, for example for imaging, of target objects comprising biological tissue, whether as discrete samples or as a part of the body of a living or dead organism. A suitable radioactive source may be introduced into and caused to spread through parts of the tissue, at least in the vicinity of the region of interest.

An example of an established nuclear medicine imaging technique is single-photon emission computed tomography (SPECT) which is a nuclear medicine tomographic imaging technique using gamma rays. The technique requires the delivery into the patient, for example via the bloodstream, of a gamma-emitting radioisotope. In a typical application, the radioisotope is bound to a specific ligand, allowing it to be carried to and bound within a region of interest in the body of the organism under investigation.

In accordance with the invention, the method comprises using a collimator with plural apertures that do not have a minimized spread angle. The apertured collimator is not a parallel hole collimator. Rather, in the apertured collimator the structure of the apertures is such that each of the apertures defines a radiation projection zone beyond the aperture that exhibits a non-zero angular spread. For example in the case of a multihole collimator each hole aperture is configured such that it defines a radiation projection cone beyond the aperture with a positive angular spread. The collimator is thus configured such that the resultant radiation projection zones beyond the apertures at the outer edges of the collimator, corresponding to the edges of the primary FOV, extend beyond the primary FOV. The collimator is preferably further configured such that the resultant radiation projection zones beyond the apertures may overlap and produce a multiplexing effect at the detector.

In embodiments, the collimator may have a one-dimensional array or a two-dimensional array of plural apertures that do not have a minimized spread angle. Apertures may be configured for example in that each aperture defines a portion from which radiation emerges that is configured, for example with reference to a short length and/or a divergent profile in an emergent radiation direction, to tend to cause radiation passing through the aperture to have a non-zero spread angle as it emerges. A suitable spread angle might be at least 15 degrees.

In some embodiments, the method comprises using a collimator with an array of slits and for example a slit-slat arrangement. In other embodiments, the method comprises using a collimator with a one-or two-dimensional array of pinholes. In such cases the slits or pinholes may be of equivalent or different configuration, and may be evenly spaced or differently spaced. Other arrangements and configurations of a plurality of apertures may be envisaged.

The multiple apertures making up an aperture array, and for example the multiple pinholes in a two-dimensional pinhole array, do not need to have identical conformance. In particular, having regard to the adaptation of the apparatus to the method of the first aspect of the invention as a means of extending the effective field of view beyond the primary field of view area, additional angular coverage could be provided by changing the shape of the apertures, such as the pinholes, in areas of the collimator close to the edges of the primary field of view, so as to be more divergent and to provide a larger angular acceptance at the edge of the detector or detector array.

In accordance with the invention, the method comprises receiving a plurality of responses to a corresponding plurality of interactions with incident radiation occurring within the detector, and for each such response determining a position in three dimensions within the detector of the said interaction.

For example, the method of the invention comprises the use of a detector adapted or configured to enable an interaction with incident radiation occurring within the detector to be localised to an interaction position within the detector in three dimensions. The method in such a case includes a step of causing radiation from the source to be incident upon such a detector and performing the receiving and determining steps accordingly.

In some embodiments for example, the invention comprises the use of a detector comprising a three-dimensional voxel array, wherein the determining for each of the plurality of responses, a characteristic of the interaction including at least a position in three dimensions of the interaction comprises localising the said interaction to a particular voxel.

In preferred embodiments, the detector comprises a means to localise an interaction within the detector to each of an x and a y direction in a plane generally perpendicular to a direction of incident radiation, and a z direction comprising a depth within the detector in a direction generally orthogonal to the x, y plane.

For example, the radiation detector comprises a detection surface divided into a plurality of separately addressable detection portions defined positionally across the detection surface in each of two orthogonal directions, hereinafter an x-direction and a y-direction, whereby an interaction at the detection module of a particle of a radiation incident from the source may be localised positionally to a detection portion; and a depth in a third orthogonal direction, hereinafter a z-direction, the radiation detector being configured such that an interaction at the detection module of a particle of a radiation incident from the source may be further localised positionally to a depth in the z direction.

The method further comprises receiving and processing, for example at a suitable processing module in data communication with the radiation detector, radiation data from a successive plurality of particle interactions at the detector, each thereby localised positionally to a particular voxel and/or to x, y and z co-ordinates.

It is a feature of embodiments of the invention that the detector localises each interaction not only in a detector x, y plane but also in a detector depth of interaction or z direction. This dataset including depth of interaction as well as position in x, y may additionally be used to reconstruct a picture of the pattern of radiation from the source in a manner that may accommodate and for example mitigate multiplexing effects. In such cases, the method of the invention is preferably further characterised by using a collimator with multiple apertures with overlapping projected radiation zones, accepting the resultant multiplexing effects in the raw data of interaction position in x, y, but using depth of interaction in z to accommodate and for example to mitigate the contribution of such multiplexing and preferably also to make further use of the multiplexing to draw additional useful inferences.

In some embodiments, the method comprises processing a collected dataset comprising the determined position and depth of each interaction within the detector and producing therefrom a modified dataset comprising at least data for a modified position of each interaction, and for example of data localising each interaction in a pixel and/or in an x, y direction as hereinabove defined, in such manner as to accommodate the effect of multiplexing due to overlap of the projected radiation pathways from multiple apertures in the collimator at the detector on the apparent position to which the interaction was localised in the input dataset.

In some embodiments, the method comprises reducing the effect of multiplexing and for example substantially eliminating the effect of multiplexing from the modified dataset.

In preferred embodiments, where the data may be used to reconstruct one or more images, the invention may further comprise using depth of interaction to accommodate multiplexing effects in the reconstructed image(s) for example to improve image quality and reducing artefacts in the reconstructed image(s).

In accordance with the invention in a further aspect, a radiation detection system for the detection of radiation from a target object is provided comprising:
a radiation source;
a radiation detector module comprising:
a detector having an area defining a primary field of view and a depth and configured to generate successive responses to successive interactions with incident radiation occurring within the detector in such manner as to determine a position of each interaction in three dimensions comprising two area dimensions and a depth dimension;
a collimator associated with the detector, wherein the collimator has a plurality of apertures having a spread angle for emergent radiation;
means to locate the radiation source internally in a target object, such that radiation from the source passes through at least a part of the target object to emerge therefrom in use, such that radiation emergent from the target object is caused to pass through the collimator to be incident upon the detector;
a processing module operable to:
receive a plurality of responses each being a response to an interaction with incident radiation occurring within the detector;
determine, for each of the plurality of responses, a position of each interaction within the detector in three dimensions comprising two area dimensions and a depth dimension;
process the said plurality of responses by simultaneously processing position data in such manner as to obtain information about parts of the target object within an effective field of view that is not directly congruent with the primary field of view. The effective field of view is for example an extended field of view or a reduced field of view as descried hereinabove in relation to the method.

The radiation detection system may comprise a single radiation detector module positioned in suitably spaced manner away from a target object locator configured to locate the target object with internal radiation source, such that radiation from the source passes through at least a part of the target object to be incident upon the detector module.

The radiation detection system may comprise two detector modules spaced away from the target object locator in any suitable juxtaposition to collect additional information. The radiation detection system may comprise three or more detector modules in any suitable two-or three-dimensional arrangement.

In a possible embodiment, two or more detector modules may be disposed around a target object locator in a suitable array such as in a planar array.

In a possible embodiment, paired detector modules are used, one each side of the target object, to collect additional information.

Thus, in this case, a radiation detection system for the detection of radiation from a target object is provided comprising:
a radiation source;
first and second radiation detector modules each comprising:
a detector having an area defining a primary field of view and a depth and configured to generate successive responses to successive interactions with incident radiation occurring within the detector in such manner as to determine a position of each interaction in three dimensions comprising two area dimensions and a depth dimension;
a collimator associated with the detector, wherein the collimator has a plurality of apertures having a spread angle for emergent radiation;
the detector and collimator together defining a detection area having means to locate the radiation source internally in a target object such that radiation emergent from the target object is caused to pass through the collimator to be incident upon each detector;
a processing module operable to:
receive a plurality of responses each being a response to an interaction with incident radiation occurring within one of the detectors;
determine, for each of the plurality of responses, a position of each interaction within the detector in three dimensions comprising two area dimensions and a depth dimension;
process the said plurality of responses by simultaneously processing position data in such manner as to obtain information about parts of the target object within the primary field of view and further information about parts of the target object beyond the primary field of view.

In embodiments, a radiation detection system for the detection of radiation from a target object is provided comprising:
a radiation source;
a radiation detector module comprising:
a detector having an area defining a primary field of view and a depth and configured to generate successive responses to successive interactions with incident radiation occurring within the detector in such manner as to determine a position of each interaction in three dimensions comprising two area dimensions and a depth dimension;
means to locate the radiation source internally in a target object, such that radiation from the source passes through at least a part of the target object to emerge therefrom in use, such that radiation emergent from the target object is caused to pass through the collimator to be incident upon the detector;
a processing module operable to:
receive a plurality of responses each being a response to an interaction with incident radiation occurring within the detector;
determine, for each of the plurality of responses, a position of each interaction within the detector in three dimensions comprising two area dimensions and a depth dimension;
process the said plurality of responses by simultaneously processing position data in such manner as to obtain information about parts of the target object within an effective field of view that is not directly congruent with the primary field of view and for example to obtain information within the primary field of view and further information about parts of the target object beyond the primary field of view;
wherein each radiation detector module comprises structural modifications to and/or is operable to vary in use of one or more of the following:
the orientation of a detector or a part thereof,
the orientation of a collimator or a part thereof,
the orientation of or shape or configuration of some of the apertures of the collimator;
at least towards the edges of the detector module, so as to increase further the angular acceptance at the edge of the detector module.

As is the case of in the method of the first aspect, and as will be understood by analogy, the invention addresses the problem of imaging with a different effective field of view (FOV) and for example outside the standard FOV of a conventional detector first by a non-parallel aperture collimation system used by the invention, so that the data in the detectors is collected within a certain angular acceptance. The part of angular acceptance going beyond the FOV defined by the detector area would provide addition area which could be imaged without extending the detector coverage to be directly above it. The invention is further characterised in that each radiation detector module comprises structural modifications to and/or is operable to vary in use one or more aspect of orientation of or shape or configuration of one or more of the elements of the detector module relative to a simple planar conformance of detector and collimator and uniform shape and configuration of apertures in such manner as to increase the angular acceptance at the edge of the detector and extend the FOV yet further to supplement the extension of the FOV that is inherently produced even in a simple planar and parallel system by the apertures having a divergent spread angle.

Example implementations above discussed herein in the context of the method will be understood to apply to the system by analogy and vice versa.

For example in some embodiments it may be useful to tilt the entire detector or collimator relative to the collimator or detector as the case may be or to a target object, or to tilt one collimator or detector or detector module of a pair relative to its pair. Alternatively, elements of the system may be modular and optionally only those modules or parts close to the edges of the primary field of view are tilted such as to provide a larger angular acceptance at the edge of the detector. Additionally or alternatively, modification may be made of the orientation of or shape or configuration of some of the apertures of the collimator in such manner as to increase the angular acceptance at the edge of the detector and extend the FOV yet further. In particular, apertures of the collimator may be configured in a non-uniform manner towards the edges of the detector module, for example being more divergent and/or outwardly directed towards the edges.

It will be appreciated that this may be effected through a fixed structural feature, for example by providing a detector module or part thereof or particular elements of a detector array that have a built in tilt angle or providing an array of apertures with non-uniform direction or divergency so as to provide a larger angular acceptance at the edge of the detector. It will be appreciated that this may be effected through an operably modifiable feature, for example by providing means operable in use to vary an orientation and for example a tilt angle of a detector module or part thereof or particular elements of a detector array.

Combinations of the above with each other and with other methods of further increasing the angular acceptance at the edge of the detector module are within the scope of the invention.

In a preferred embodiment, the system is configured such that the radiation detector module and the collimator are relatively configured to define a scanning region such that the distance between the radiation detector module and the collimator is smaller than the distance between the collimator and the scanning region.

In the preferred case, where first and second radiation detector modules are provided either side of a target object, the respective radiation detector modules and the collimators are relatively configured to define a scanning region between them such that the distance between each radiation detector module and its collimator is smaller than the distance between the collimator and the scanning region.

In some embodiments the system is configured to perform a static scan as above described. That is, the detector module(s) are maintained in a fixed position relative to the target object.

In some embodiments the system is configured to perform a moving scan as above described. That is, the detector module(s) are configured to be movable relative to the target object around the primary field of view, and for example about an imaging axis that is an axis of symmetry for the field of view. In an example as above described where the field of view is defined as the volume projected by projecting the detection plane in a normal direction to the detector, such an imaging axis may be defined perpendicular to the detection plane.

In each such case the invention could potentially extend the axial field of view (that is, the field of view in parallel with the imaging axis).

In use a target object is positioned such that a region of interest is within the primary field of view in the scanning region so as to exploit the extended FOV and minification effects discussed herein in respect of the first aspect of the invention.

Thus, in particular, the system is preferably a system adapted to perform the method of the first aspect of the invention.

In embodiments therefore, the processing module is further operable to perform in any appropriate combination one or more of the determining or processing steps of the method of the invention as herein defined.

In embodiments, the detector is itself adapted or configured to enable an interaction with incident radiation occurring within the detector to be localised to at least a position and depth of the interaction within the detector.

The system is in particular a system adapted for the performance of the method of the first aspect, and preferred features of each aspect will be understood to be applicable to the other.

In particular, the processing module of the system may be operable to, and/or the system may further comprise additional modules such as an imaging module operable to, perform any of the steps of the method of the method of the first aspect of the invention.

In embodiments, the detector is adapted or configured to enable an interaction with incident radiation occurring within the detector to be localised to an interaction position within the detector in three dimensions.

In embodiments, the detector has a detector x, y plane and a detector z direction orthogonal thereto; and the processing module is operable to localise each interaction to a position in a detector x, y plane and to a depth of the interaction in a detector z direction. In some embodiments, the detector is adapted or configured to enable an interaction with incident radiation occurring within the detector to be so localised.

In embodiments, the detector is pixelated into a plurality of separately addressable detector sub-units as above defined; and the processing module is operable to localise each interaction to a particular sub-unit and to a depth of the interaction therein. In some embodiments, the detector is adapted or configured to enable an interaction with incident radiation occurring within the detector to be so localised.

In embodiments, the collimator may have a one-dimensional array or a two-dimensional array of plural apertures. Apertures may be configured, for example with reference to a short length and/or a divergent profile in an emergent radiation direction, to tend to cause radiation passing through the aperture to have a non-zero spread angle as it emerges. A suitable spread angle might be at least 15 degrees.

In some embodiments, the collimator comprises plural slits and for example a slit-slat arrangement. In other embodiments, the collimator comprises a two-dimensional array of pinholes. Other arrangements of plural diverging apertures may be envisaged.

In some embodiments for example, the detector is a voxel detector comprising a three-dimensional voxel array. In such a case, determining, for each of the plurality of responses, a characteristic of the interaction including at least a position in three dimensions of the interaction comprises localising the said interaction to a particular voxel.

In some embodiments, the detector comprises a means to localise an interaction within the detector to each of an x and a y direction in a plane generally perpendicular to a direction of incident radiation, and a z direction comprising a depth within the detector in a direction generally orthogonal to the x, y plane.

For example, the detector comprises a detection surface divided into a plurality of separately addressable detection portions defined positionally across the detection surface in each of two orthogonal directions, hereinafter an x-direction and a y-direction, whereby an interaction at the detection module of a particle of a radiation incident from the source may be localised positionally to a detection portion; and a depth in a third orthogonal direction, hereinafter a z-direction, the radiation detector being configured such that an interaction at the detection module of a particle of a radiation incident from the source may be further localised positionally to a depth in the z direction.

Thus, the detector is configured to enable a determination of a depth of interaction (that is, a dimension in a z-direction) at which each photon interaction occurs. This may be achieved in any suitable way by combination of materials, structural features and processing electronics.

For example, a detector may be fabricated from a material that inherently allows depth of interaction information to be extracted, such as a bulk crystal cadmium telluride type solid state semiconductor detector. The materials making up the semiconductor detector are for example selected from cadmium telluride, cadmium zinc telluride (CZT), cadmium manganese telluride (CMT) and alloys thereof, and for example comprise crystalline Cd_{1-(a+b)}MnₐZn_{b}Te where a+b<1 and a and/or b may be zero. Bulk single crystal detectors may be particularly preferred.

Additionally or alternatively, the detector may comprise multiple discrete layers in a z-direction of suitable detector materials. For example, multi-layer scintillator detectors may be suitable for implementation of the invention.

In some embodiments, the method further comprises generating an image and optionally further displaying the image. The system may further comprise an image generation module for generating an image and an image display. The method may further comprise generating successive images as a tomographic reconstruction. The system may further comprise a tomographic reconstruction module to effect the same.

In some embodiments, the image is a tomographic image and the image generation module comprises a tomographic image reconstruction module for generating successive images as a tomographic reconstruction, for example utilising the 3D location of detected events to account for uncertainties in the origin of radioactivity. Optionally, this may be done directly within the reconstruction or as a prior processing step. Optionally, hybrid approaches such as the hybrid method explored below may be employed.

Other preferred features of the system of the second aspect will be understood by analogy from the discussion of the method of the first aspect and vice versa.

### BRIEF DESCRIPTION OF DRAWINGS

The invention will now be described by way of example only with reference to FIGS. 1 to 10 of the accompanying drawings, in which:

FIG. 1 illustrates the principle of multiple-pinhole multiplexing, showing a pinhole collimator being an example of a multiplexing filter for application in the system and method of the invention;

FIG. 2 shows schematically the principles of a pair of detectors, for example suitable for use in tomographic imaging, in a first possible configuration with the FOV extended in accordance with the principles of the invention;

FIG. 3 shows schematically the principles of a pair of detectors, for example suitable for use in tomographic imaging, in an alternative configuration with the FOV extended in accordance with the principles of the invention;

FIG. 4 shows an extended FOV tomography using such a system;

FIG. 5 shows possible rotating embodiments of a two detector system;

FIG. 6 shows a more complex moving scanning system;

FIG. 7 shows schematically the principles of a pair of detectors, for example suitable for use in tomographic imaging, in a second possible configuration with the FOV reduced in accordance with the principles of the invention;

FIG. 8 shows reconstructed images of three line-sources with a low background activity concentration for detector angulations of 0° (a), 10° (b), 20° (c) and 30° (d);

FIG. 9 shows estimated resolution (FWHM) for the three line-sources at 0, 25 and 50 mm from the centre in the x- (a) and y-dimension (b) as a function of detector angle;

FIG. 10 shows relative system sensitivity for different configurations as a function of detector angle.

### DETAILED DESCRIPTION

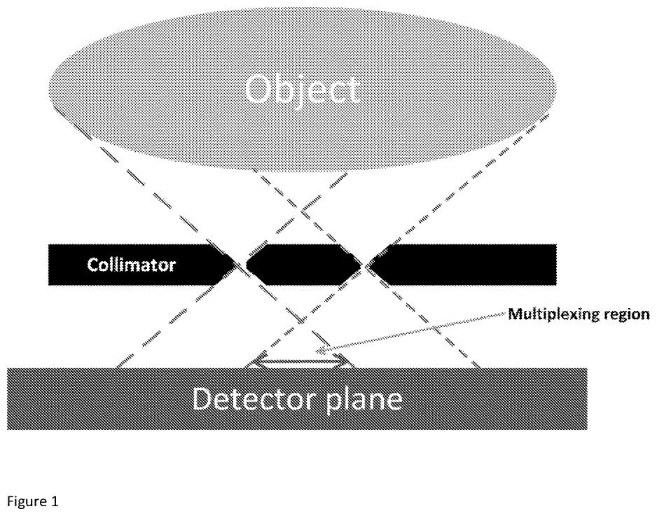

FIG. 1 illustrates the principle often referred to as multiple-pinhole image multiplexing, showing a pinhole collimator being used to project an image from a source to a detection plane. This principle is described generally for example in WO2021/176232A1. The source is for example a part of a biological system under investigation, into which a radioactive species has been introduced and caused to spread.

The data from photons incident upon the detectors is collected within a certain angular acceptance around the detector array. This principle may be exploited in familiar manner for tomographic imaging, for example in a modified MBI system.

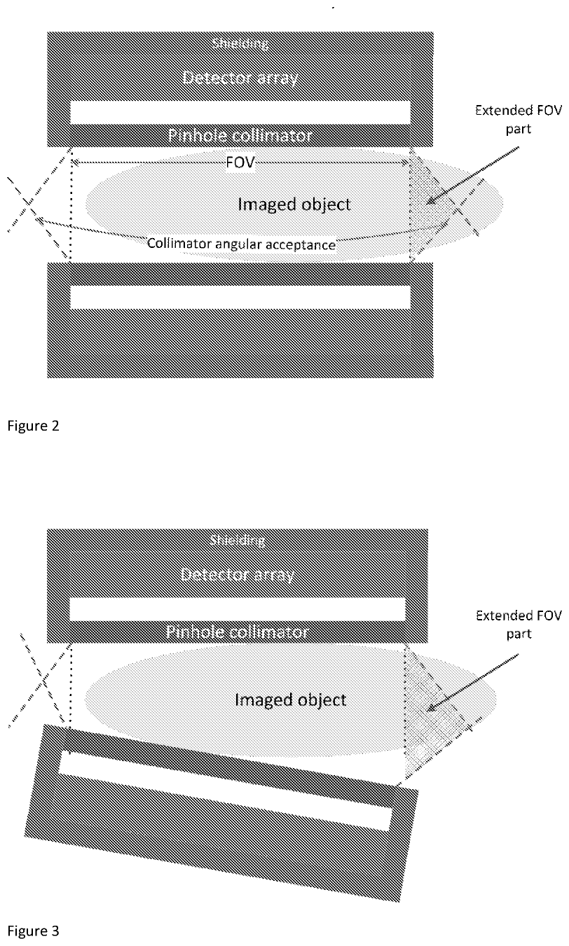

The general principles of this are illustrated schematically in FIGS. 2 and 3. FIGS. 2 and 3 show a possible system, which may be for tomographic imaging, for example an MBI system, with its FOV extended in accordance with the principles of the invention. Where applied to tomographic imaging for medical purposes, for example in such a modified MBI system, the skilled person will readily be able to infer the necessary structures and methodology for its implementation.

In such application for MBI use, the principle is admirably suited to addressing the problem of imaging the tissue near the chest wall, which is outside of the FOV of a conventional MBI camera.

In a parallel hole collimation MBI system, the FOV of is limited to the area which is directly above the detector array. Therefore, none of the tissue which is outside that area could be imaged.

In a (multi-)pinhole collimation system, the data in the detectors is collected within a certain angular acceptance around the detector array. The part of angular acceptance going beyond the primary FOV defined conventionally by the detector area would provide additional area which could be imaged without extending the detector coverage to be directly above it. The general principle is illustrated in FIG. 2.

The detector planes could be either parallel one to another as in FIG. 2 or one of them or both could be tilted thus providing even bigger extension to the coverage as shown in FIG. 3.

In the illustrated embodiment it can be seen that the distance between each detector array and its respective collimator will be smaller than the distance between the collimator and the extended FOV region of interest (ROI) of the imaged object. Therefore the method would usually involve minification and not magnification as in known methods.

Thus, two principles are exploited to give additional functionality: The part of angular acceptance going beyond the primary FOV may be imaged without extending the detector coverage to be directly above it, and the generation of a minified image may be used co-operably with this to collect and present in a tomographic or other image more information from a target object for any given process and level of irradiation. Particular advantages may accrue from this in the embodiment as an MBI system to provide for improved physiologically relevant images from the breast of a patient and/or reduced radiation dose levels for a given image.

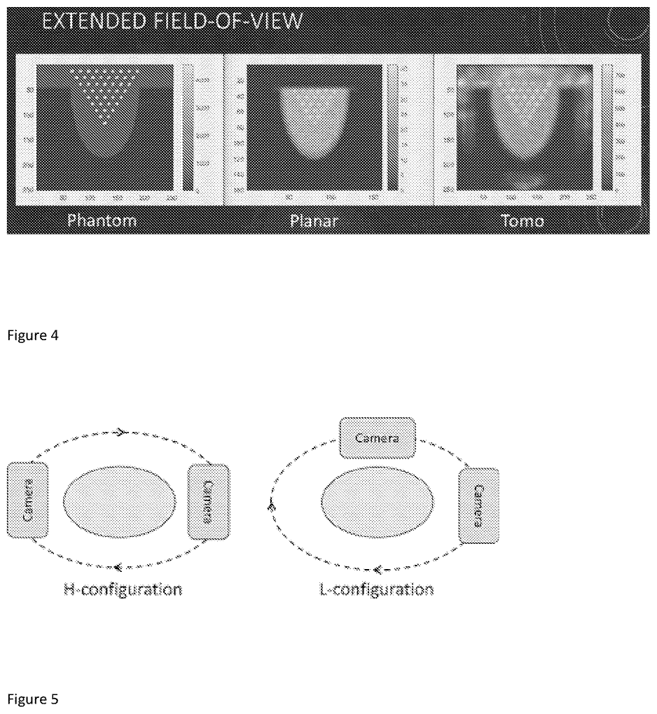

A basic simulation of the dual detector head system has been performed as shown in FIG. 4. Additional information is provided by operation in accordance with the method of the invention.

It is not necessary to tilt the whole detector plane. The plane may be comprised of multiple detectors arranged in a certain array. It could be enough to change orientation only of some of the detectors, in particular those which are close to the edge of the array, to obtain a similar result. The orientation of the individual detectors can be either fixed or can be potentially adaptable to the requirements of the particular examination, and it doesn't have to be the same.

Compared to prior art, the suggested method does not rely on the movement of the detectors during scans. Stationary acquisitions are possible due to the unique design of the collimator-detector system, which in turn is made possible by detector technology that collects data for depth of interaction in a detector z direction in addition to data for the interaction in an x, y plane of the detection surface. A detector that is inherently able to do this is preferred.

In particular embodiments a thick bulk semiconductor detector of cadmium zinc telluride (CZT) is used. Such a detector intrinsically allows for a depth of a photon interaction in a z direction as well as a location in a particular pixel in x, y to be determined. The invention is not limited to such detectors however. Such a semiconductor detector could be replaced by any “depth sensing” or “3D position sensing” detector structure, including for example scintillator detector modules made of a few layers to provide some depth sensing.

In some operational embodiments the system may be used to obtain a static scan. The detector modules are maintained in a fixed position relative to the target object as successive responses to successive interactions are collected.

The invention could also provide extended FOV in a case of a rotating camera(s) arrangement but in practice this is likely to be limited to the axial (i.e. along the rotation axis) direction. The detector(s) (one, two, or more) are moving around the field of view. In most cases, the movement is a simple rotation around the imaging axis.

For example, in FIG. 5 two alternative configurations of two-module systems are shown.

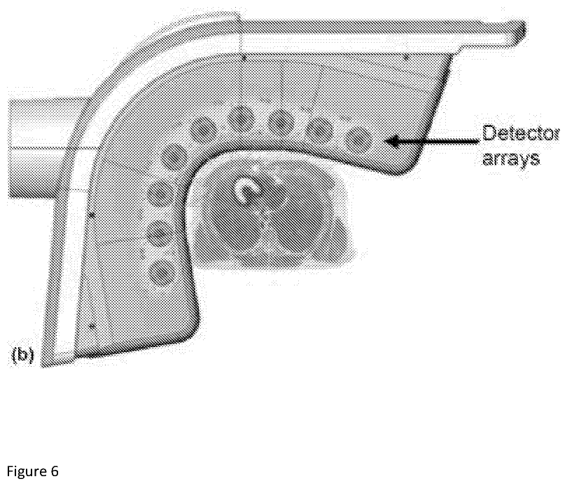

In other cases, for example as shown in FIG. 6, the detectors engage into flip-like motion around their own axis.

In all such cases, the invention could potentially extend the axial field of view (i.e. in parallel with the imaging axis).

In yet further alternatives, there may be multiple static detectors in a ring-like arrangement. Again, our invention would extend the axial field of view (where the axis is perpendicular to the detector ring).

FIGS. 7 to 10 show an alternative arrangement where the effective field of view is reduced and an increased resolution is obtained within that reduced FOV.

FIG. 7 shows schematically the principles of a pair of detectors, for example suitable for use in tomographic imaging, in a second possible configuration with the FOV reduced in accordance with the principles of the invention. This invention relates to a technique to improve both resolution and sensitivity over a reduced field-of-view (FOV) by introducing some flexibility in terms of detector orientation. For cases in which the entire FOV is not required, the external parts of the detector arrays can be tilted towards the centre, thereby improving angular sampling and sensitivity over a reduced FOV. This can be of the form of tilted detectors or angled pinholes. The system could still be stationary during acquisition. An extension of the technique allows for increasing or decreasing the field of view on each edge of the detector system, to allow for increased field of view or improved spatial resolution in different regions of the object to be scanned. One specific application where this technique can be appropriated is for use in tomosynthesis, where as an example the depth of interaction resolution could be improved.

The technique is particularly suited to application using densely packed multipinholes for collimation. We performed computer simulations, assuming 198 mm wide detector arrays, divided into 3 sections, such that the first and last sections could be tilted by different angles.

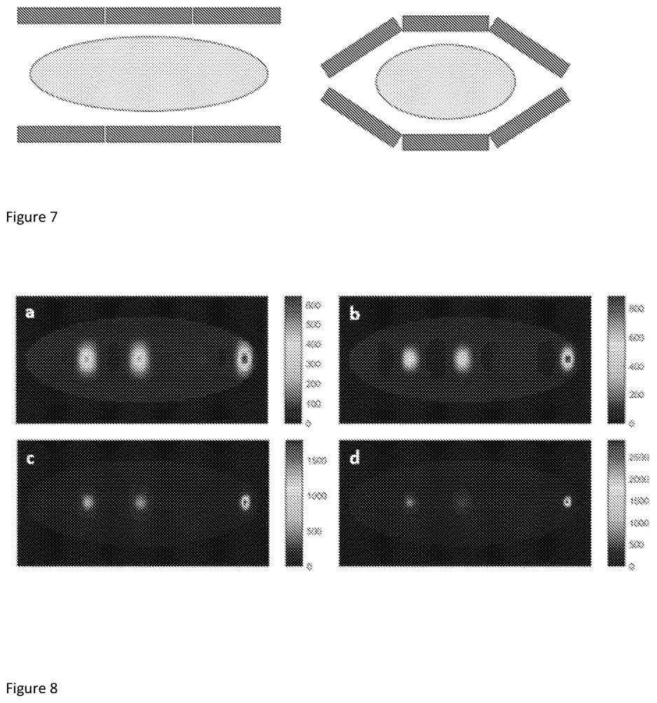

Results of simulations are shown in FIGS. 8 to 10. The width of each detector array was 198 mm, and could be divided into three sections. The first and last sections could be tilted by different angles, as shown in FIG. 1. The pinhole separation was 11 mm and the detector separation 70 mm. The activity distribution consisted of an elliptical cylinder of low background concentration and three line-sources, placed on the mid-plane between the detectors at different distances from the centre in the horizontal direction (x=0, −25 and 50 mm). Noise-free projection data were generated by forward projection. MX was not applied, assuming ideal de-MX. This was considered reasonable in this case, as we were only interested in comparing different detector geometries. Data were generated for detector angulations of 0°, 10°, 20° and 30°. Images were reconstructed with 20 MLEM iterations. The images were integrated in the axial dimension and each source was fitted with a 2D Gaussian function for estimation of the FWHM in the x-and y-dimensions. The relative system sensitivity for the different configurations was estimated based on the total number of counts in the projection data. All data processing and analysis were done in MATLAB.

FIG. 8 shows reconstructed images of three line-sources with a low background activity concentration for detector angulations of 0° (a), 10° (b), 20° (c) and 30° (d). The image corresponding to the standard configuration (a), shows that the resolution is slightly better for the x=50 mm source. This is because it is close to the edge of the elliptical background region, which speeds up convergence. It can also be seen that the resolution improves with increasing detector angle (b-d).

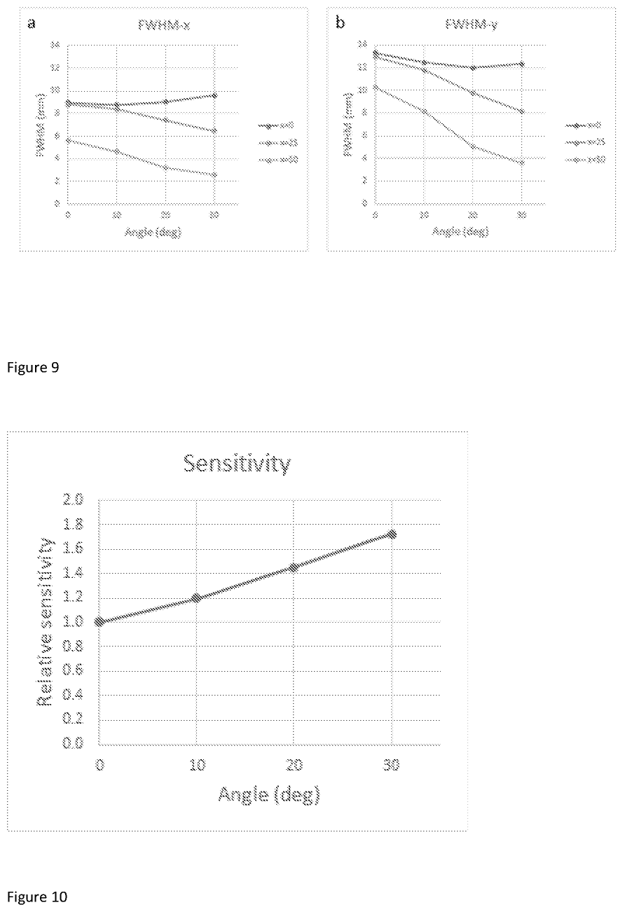

FIG. 9 shows estimated resolution (FWHM) for the three line-sources at 0, 25 and 50 mm from the centre in the x- (a) and y-dimension (b) as a function of detector angle. In most cases the resolution improves (reduced FWHM) with increasing angle. The improvement is more pronounced in the y-dimension (perpendicular to the detectors).

FIG. 10 shows relative system sensitivity for different configurations as a function of detector angle. The sensitivity increases approximately linearly with increasing angle.

On average for the three line-sources, the resolution was improved (reduced FWHM) by factors of 0.92, 0.81, and 0.76 in the x-direction and 0.88, 0.72 and 0.64 in the y-direction for detector tilt angles of 10°, 20° and 30°, respectively. The sensitivity was increased by factors of 1.19, 1.45 and 1.72, respectively, for the same angles. The improvements are due to both increased angular sampling and reduced detector distance. The greatest resolution improvement (by a factor close to 3) was observed in the y-dimension for the source furthest from the centre (x=50 mm).

Our simulations show that, by introducing some flexibility in the detector configuration, it is possible to improve both spatial resolution and sensitivity by sacrificing part of the FOV. However, the standard configuration would still be with two opposing parallel planar detectors.

Thus, solutions are offered in MBI and other nuclear medicine imaging systems/methodologies in particular, that, by exploiting the FOV extension or reduction and/or minification functionalities discussed herein, allow for the resolution and imaging of information concerning radiation from a target ROI where a low level of radiation level at the body is desirable and provide for improved resolution of physiologically relevant data from a subject and/or reduced radiation dose levels.

1-30. (canceled)

31. A method of detecting radiation from a target object, comprising:
providing a radiation detector module comprising:
a detector having an area and a depth and configured to generate successive responses to successive interactions with incident radiation occurring within the detector in such manner as to determine a position of each interaction in three dimensions comprising two area dimensions and a depth dimension; and
a collimator associated with the detector, wherein the collimator has a plurality of apertures having a spread angle for emergent radiation;
positioning the radiation detector module relative to a region of interest of the target object to define, where the detector module area faces the target object, a primary field of view;
associating the target object with an internal radiation source such that radiation emergent from the target object is caused to pass through the collimator to be incident upon the detector;
receiving a plurality of responses each being a response to an interaction with incident radiation occurring within the detector;
determining, for each of the plurality of responses, a position of each interaction within the detector in three dimensions comprising two area dimensions and a depth dimension; and
processing the said plurality of responses by simultaneously processing position data in such manner as to obtain information about parts of the target object within an effective field of view that is not directly congruent with the primary field of view.

32. The method in accordance with claim 31, comprising providing paired detector modules, one each side of the target object.

33. The method in accordance with claim 31, comprising:
providing first and second radiation detector modules each comprising:
a detector having an area and a depth and configured to generate successive responses to successive interactions with incident radiation occurring within the detector in such manner as to determine a position of each interaction in three dimensions comprising two area dimensions and a depth dimension;
a collimator associated with the detector, wherein the collimator has a plurality of apertures having a spread angle for emergent radiation;
positioning the first and second radiation detector modules with a region of interest of the target object between them to define where the respective detector module areas overlap a primary field of view;
associating the target object with an internal radiation source such that radiation emergent from the target object is caused to pass through the respective collimators to be incident upon the respective detectors;
receiving a plurality of responses each being a response to an interaction with incident radiation occurring within one of the detectors;
determining, for each of the plurality of responses, a position of each interaction within the detector in three dimensions comprising two area dimensions and a depth dimension; and
processing the said plurality of responses by simultaneously processing position data in such manner as to obtain information about parts of the target object within an effective field of view that is not directly congruent with the primary field of view.

34. The method in accordance claim 31, wherein the obtaining information about parts of the target object within an effective field of view that is not directly congruent with the primary field of view comprises simultaneously processing position data in such manner as to obtain information about parts of the target object within the primary field of view and further information about parts of the target object beyond the primary field of view.

35. The method in accordance with one of claim 31, wherein the obtaining information about parts of the target object within an effective field of view that is not directly congruent with the primary field of view comprises simultaneously processing position data in such manner as to obtain information about parts of the target object within a field of view that is reduced relative to the primary field of view.

36. The method in accordance with claim 31, wherein each radiation detector module is further modified by modification of one or more of the following: the orientation of a detector or a part thereof, the orientation of a collimator or a part thereof, the orientation of or shape or configuration of some of the apertures of the collimator at least towards the edges of the detector module, so as to increase further the angular acceptance at the edge of the detector module.

37. The method in accordance with claim 31, further comprising: positioning the radiation detector module and the collimator relatively to the region of interest of the target object such that the distance between the radiation detector module and the collimator is smaller than the distance between the collimator and the region of interest.

38. The method in accordance with claim 37, comprising:
providing first and second radiation detector modules are provided either side of a target object; and
positioning each radiation detector module and its respective collimator relatively to the region of interest of the target object such that the distance between the radiation detector module and the collimator is smaller than the distance between the collimator and the region of interest.

39. The method in accordance with claim 31, wherein the detector defines a generally planar detection surface in use presented to face and to receive incoming radiation from a test object.

40. The method in accordance with claim 39, wherein a primary field of view is defined by projecting the detection surface in a normal direction to the plane.

41. The method in accordance with claim 31, wherein the detector comprises a plurality of discrete detector formations arranged in a two-dimensional array.

42. The method in accordance with claim 39, wherein the method includes to change orientation and tilt relative to a detector plane of some of the detector formations.

43. The method in accordance with claim 31, wherein a static scan is made in that at least one of the detector modules is maintained in a fixed position relative to the target object and the method comprises receiving a plurality of responses each being a response to an interaction with incident radiation occurring within the detector while the detector is in a fixed position relative to the target object.

44. The method in accordance with any one of claim 31, wherein a moving scan is made in that at least one of the detector modules is moved relative to the target object around the primary field of view and the method comprises receiving a plurality of responses, successive responses being responses to successive interactions with incident radiation occurring within the detector while the detector is so moved relative to the target object.

45. The method in accordance with claim 44, wherein during the scan at least one of the detector modules is moved relative to the target object about an imaging axis that is an axis of symmetry for the primary field of view.

46. The method in accordance with claim 44, wherein the method includes to change orientation and tilt relative to a general detector plane only some of the detector formations which comprise a part of the said array at or towards the edge of the detector.

47. The method in accordance with claim 31, further comprising processing the said plurality of responses to generate an image of the target object.

48. The method in accordance with claim 47 comprising processing the said plurality of responses by simultaneously processing position data in such manner as to obtain imaging information about parts of the target object within the primary field of view and further in imaging information about parts the target object beyond the primary field of view, and co-operably processing the said imaging information to produce an image of the target object that extends beyond that which would be produced from the primary field of view.

49. The method in accordance with claim 47, comprising:
arranging the system such that the distance between each radiation detector module and its collimator is smaller than the distance between the collimator and the region of interest; and
processing the said plurality of responses by simultaneously processing position data in such manner as to obtain minified imaging information from the target object and co-operably processing the said imaging information to produce a minified image of the target object.

50. The method in accordance with one of claim 47, wherein the image is a reconstructed tomographic image.

51. The method in accordance with claim 31, wherein the collimator comprises a one-dimensional array or a two-dimensional array of plural apertures that do not have a minimized spread angle.

52. The method in accordance with claim 51, wherein the apertures have a spread angle of at least 15 degrees.

53. The method in accordance with claim 31, further comprising configuring the collimator such that the shape of a plurality of apertures having a spread angle for emergent radiation is modified in areas of the collimator close to the edges of the primary field of view so as to be more divergent and to provide a larger angular acceptance at the edge of the detector.

54. A radiation detection system for the detection of radiation from a target object comprising:
a radiation source;
a radiation detector module, comprising:
a detector having an area defining a primary field of view and a depth and configured to generate successive responses to successive interactions with incident radiation occurring within the detector in such manner as to determine a position of each interaction in three dimensions comprising two area dimensions and a depth dimension;
a collimator associated with the detector, wherein the collimator has a plurality of apertures having a spread angle for emergent radiation; and
means to locate the radiation source internally in a target object such that radiation emergent from the target object is caused to pass through the collimator to be incident upon the detector;
a processing module operable to:
receive a plurality of responses each being a response to an interaction with incident radiation occurring within the detector;
determine, for each of the plurality of responses, a position of each interaction within the detector in three dimensions comprising two area dimensions and a depth dimension;
process the said plurality of responses by simultaneously processing position data in such manner as to obtain information about parts of the target object within an effective field of view that is not directly congruent with the primary field of view.

55. A radiation detection system in accordance with claim 54, comprising:
a radiation source;
first and second radiation detector modules each comprising:
a detector having an area defining a primary field of view and a depth and configured to generate successive responses to successive interactions with incident radiation occurring within the detector in such manner as to determine a position of each interaction in three dimensions comprising two area dimensions and a depth dimension;
a collimator associated with the detector, wherein the collimator has a plurality of apertures having a spread angle for emergent radiation;
the detector and collimator together defining a detection area having means to locate the radiation source internally in a target object such that radiation emergent from the target object is caused to pass through the collimator to be incident upon each detector;
a processing module operable to:
receive a plurality of responses each being a response to an interaction with incident radiation occurring within one of the detectors;
determine, for each of the plurality of responses, a position of each interaction within the detector in three dimensions comprising two area dimensions and a depth dimension;
process the said plurality of responses by simultaneously processing position data in such manner as to obtain information about parts of the target object within an effective field of view that is not directly congruent with the primary field of view.
